(19) United States
(12) Patent Application Publication
(10) Pub. No.: US 2020/0140039 A1
(43) Pub. Date: May 7, 2020

(54) BOAT WITH AN IMPROVED BUOYANT BODY

(71) Applicant: MLRB SDN. BHD, Sarawak (MY)

(72) Inventor: Ting-Wei Chang, New Taipei City (TW)

(21) Appl. No.: 16/182,925

(22) Filed: Nov. 7, 2018

(51) Int. Cl. B63B 5/24; B63B 1/04; B32B 5/02; B32B 27/06; B32B 27/12; B32B 27/30

(52) U.S. Cl. CPC B63B 5/24; B63B 1/04; B32B 5/028; B32B 2605/12; B32B 27/12; B32B 27/304; B32B 2262/103; B32B 27/065

(57) ABSTRACT

The present invention relates to a boat with an improved buoyant body, comprising: a buoyant body, which is an U-shaped tube, consisted of a cladding and foam material filled therein; a bottom plate, set on the bottom of the buoyant body; a tail plate, set at the rear of the buoyant body and the bottom plate; wherein the cladding of the buoyant body is consisted of an inner layer and two outer layers, cladding the said inner layer; wherein the inner layer is a net, while the outer layers are sheets; thereby it is achieved, that the buoyant body possesses the features of low weight, high strength and high friction resistance.

### TECHNICAL FIELD

The present invention relates to a boat with an improved buoyant body; particularly to a boat with an improved buoyant body, which is consisted of a first cladding and foam material filled in the said first cladding; wherein there is improved structure of the first cladding,

### BACKGROUND ART

Patent document 1: Taiwan patent publication Nr. M381588

As shown in FIG. 4-5, in the patent document 1 the applicant disclosed an “Anti-overturned onshore lifeboat”, it is characterized in that a buoyant body 8 is consisted of a cladding 81 as well as foam material filled in the cladding 81. Even the cladding is damaged accidentally, problems like water seepage within the cladding or impairment of buoyancy are avoided. After years of development, such a boat with a foam filled cladding of a buoyant body can be termed as a foam filled boat 800.

A conventional foam filled boat 800 is based on a rubber boat and further developed. Thereby, lot of costs for structural design is saved. Besides, a cladding 81 of the buoyant body 8 is filled with foam material 82, whereby strength of the buoyant body 8 is enhanced. Hence, it is widely applied to lifeboat, transport boat, fishing boat and so on.

However, the conventional cladding 81 of the buoyant body 8 is derived from the idea of a rubber boat, wherein it is made of high-strength rubber or canvas. As result the strength of the buoyant body is limited and cannot be applied to more fields. Besides, the conventional cladding 81 is made of multi-layers composite material. However, the single layers of the conventional cladding 81 are fixed by glue. But such problems exist: strength of the buoyant body 8 is affected due to Insufficient adhesion, and glue adhesion is affected by the foaming temperature during foaming process.

In view of these disadvantages the inventor tried the continuous testing and improvement and developed the present invention.

### SUMMARY OF THE INVENTION

The main object of the present invention is to provide a boat with an improved buoyant body, wherein the buoyant body possesses the features of low weight, high strength and high friction resistance.

For achieving above object, the present invention provides a boat with an improved buoyant body, comprising: a buoyant body, which is an U-shaped tube, consisted of a first cladding and foam material filled in the first cladding; a bottom plate, set on the bottom of the buoyant body; a tail plate, set at the rear of the buoyant body and the bottom plate; wherein the first cladding of the buoyant body is consisted of a first inner layer as well as two first outer layers, which clad the said first inner layer on the both sides; wherein the first inner layer is a net, while the first outer layers are sheets.

Preferably, the first inner layer is made of steel wire; while the first outer layers are made of polyvinyl chloride, whereby strength, tension and heat resistance of the first cladding are enhanced.

Preferably, the first inner layer is fixed by melt bonding method.

Preferably, outside around the buoyant body is set a cylindric anti-collision tube, as a protective structure for the buoyant body.

Preferably, the anti-collision tube is consisted of a second inner layer and two second outer layers, which clad the second inner layer on the both sides, whereby the second cladding can possess various features.

Preferably, the second inner layer is a net made of steel wire; the second outer layers are sheets made of polyvinyl chloride, whereby strength, tension and heat resistance of the second cladding are enhanced.

Preferably, the both second outer layers are fixed therebetween by melt bonding method.

The present invention disclosed a first cladding of the buoyant body, wherein the first cladding is consisted of a first inner layer made of steel wire net and two first outer layers made of polyvinyl chloride sheets. Thereby it is free from restriction of inherent concepts and it is achieved that the buoyant body possesses the features of low weight, high strength and high friction resistance.

Other aspects and advantages of the present invention will become apparent from the following detailed description, taken in conjunction with the accompanying drawing, illustrating by way of example the principles of the present invention.

### BRIEF DESCRIPTION OF THE DRAWINGS

FIG. 1 is a three-dimensional view of the present invention.

FIG. 2 shows the structure of a buoyant body of the present invention.

FIG. 3 is a sectional view of a buoyant body and an anti-collision tube of the present invention.

FIG. 4 is a three-dimensional view of a conventional foam filled boat.

FIG. 5 is a sectional view of a buoyant body and an anti-collision tube of a conventional foam filled boat.

### DETAILED DESCRIPTION OF PREFERRED EMBODIMENTS

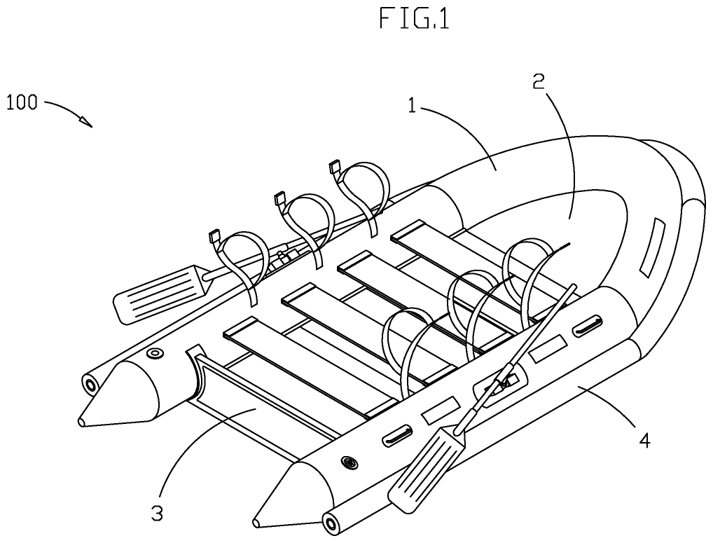

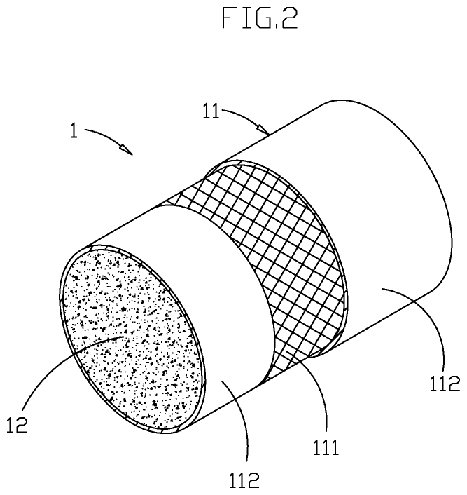

As shown in FIG. 1-2, the present invention a boat 100 with an improved buoyant body comprises: a buoyant body 1, which is an U-shaped tube, consisted of a first cladding 11 and foam material 12 filled the said first cladding 11; a bottom plate 2, set on the bottom of the buoyant body 1; and a tail plate 3, set at the rear of the buoyant body 1 and the bottom plate 2; wherein the cladding of the buoyant body 1 is consisted of an first inner layer 111 and two outer layers, which clad the inner layer 111; thereby it is achieved, that the buoyant body 1 possesses the features of low weight, high strength and high friction resistance.

Since the first cladding 11 and the foam material 12, which consist the buoyant body 1, are characterized by low specific gravity, thus the buoyant body 1 has a destined size for having destined buoyancy, and yet keeps low weight. Besides, since the first cladding 11 is filled with the foam material 12, even the first cladding 11 accidentally damaged, problems which impair buoyancy like, water seepage within the first cladding 11 or leakage of the foam material 12 filled in the first cladding 11, are avoided.

The buoyant body 1, the bottom plate 2 and the tail plate 3 build up a strong buoyant body, to carry people or wares.

As shown in FIG. 2, the first cladding 11 of the buoyant body 1 is consisted of a first inner layer 111 and two first outer layers 112, which clad the first inner layer 111, wherein the first inner layer 111 and the first outer layers 112 are made of different materials, whereby the first cladding possess various features.

The first inner layer 111 is a net, made of high strength material, e.g. steel wire, whereby the first cladding 11 is enhanced.

The first outer layers 112 are sheets, made of high tension and heat resistance material, e.g. polyvinyl chloride (PVC), whereby tension and heat resistance of the first cladding 11 is enhanced. Besides, due to the material features of the first outer layers 112, the both first outer layers 112 therebetween by melt bonding method, and furthermore fixed with the first inner layer 111 together.

By using different materials for the first inner layer 111 as well as the first outer layers 112, various material features of the first cladding 11 are enhanced. Furthermore, through supporting of the first inner layer 111 to the first outer layers 112, friction resistance of the first outer layers 112 is enhanced also, hence friction of the first cladding 11 is enhanced.

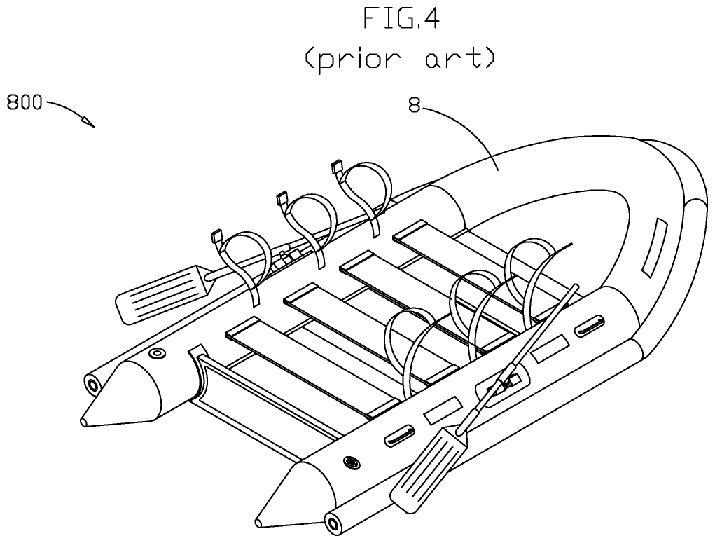

FIG. 4 is a three-dimensional view of a conventional foam filled boat. The present invention is characterized in that, the first cladding 11 of the buoyant body 1 is consisted of a first inner layer 111 and two outer layers 112, which clad the said first inner layer 111 on both sides (as shown in FIG. 1-3), wherein the appearances of accessories, like Seat belt, handle and paddle, are not affected.

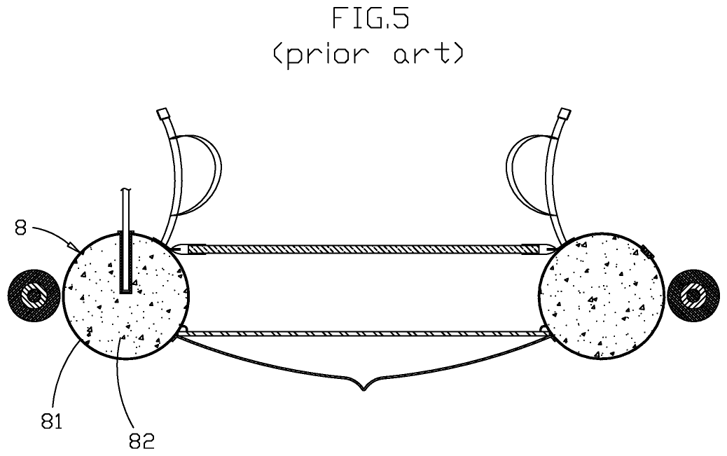

As shown in FIG. 4-5, a conventional foam filled boat 800 is based on a rubber boat developed, thereby lot of costs for structural design is saved. However, concepts are restricted, e.g. a cladding 81 of a conventional buoyant body 8 is following the concept of a rubber boat, made of high-strength rubber or canvas.

The applicant of the present invention has disclosed, that there are two reasons for using high-strength rubber or canvas for cladding a conventional rubber boat:

1. A cladding needs destined strength and tension to carry pressure, resulted by filling gas as well as to buffer partial compression during using; 2. A cladding is easy foldable for transport and storage after gas has been released. But for the conventional foam filled boat 800 it is not passible to release the foam material 82 for transport and storage. Therefore, it is not necessary to take off the foam material 82 from the cladding 81 for transport or storage. In this case, there is no restriction to material choice of the cladding 81, e.g. foldable material. Hence the range of usable materials is extended. Based on this fact the present invention is developed. The present invention comprising the first cladding 11, consisted of a first inner layer 111 made of steel wire net as well as two first outer layers 112 made of polyvinyl chloride sheet, whereby it is free from restriction of inherent concepts. Thereby it is achieved, that the buoyant 1 possesses the features of low weight, high strength and high friction resistance.

As shown in FIG. 1, outside around the buoyant 1 there is a cylindric anti-collision tube 4, which not only builds up an anti-collision protective structure, but also improves stability of the buoyant body. At the same time, it can provide steps for people in water, while climbing the buoyant body.

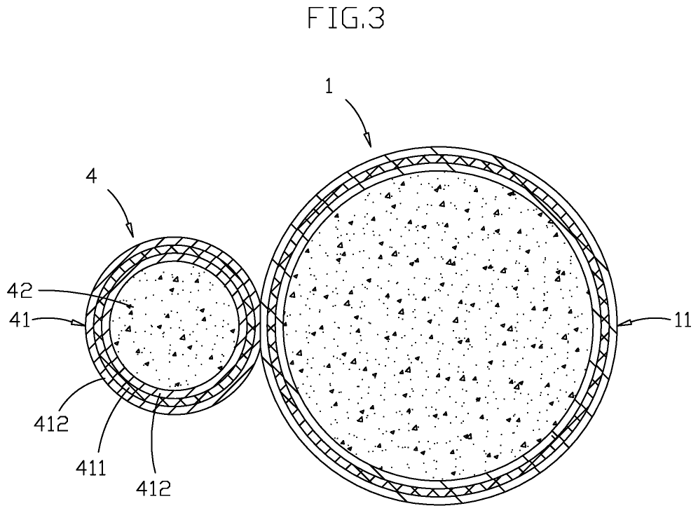

As shown in FIG. 3, the anti-collision tube 4 is consisted of a second cladding 41 and foam material 42 filled in the said second cladding 41. Besides, the second cladding 41 of the anti-collision tube 4 has the same structure as the first cladding 11 of the buoyant body 1, that is, it is consisted of a second inner layer 411 made of steel wire net as well as two second outer layer made of polyvinyl chloride sheets, which clad the second inner layer 411. Thereby the anti-collision tube 4 possesses the same features as the buoyant body 1 of low weight, high strength and high friction resistance. The second outer layers 412 of the anti-collision tube 4 are fixed therebetween by melt bonding method, and furthermore fixed with the second inner layer 411.

The second outer layers 412 of the second cladding 41 and the first outer layers 112 of the first cladding 11 are fixed together by melt bonding method, whereby easy manufacturing, costs saving as well as enhanced connection strength between the anti-collision tube 4 and the buoyant body 1 are achieved.

Foam material is used for the filling material 42 of the anti-collision tube 4, also other mixed material of higher specific gravity is possible, whereby stability of the buoyant body 1 is improved.

While preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A boat with an improved buoyant body, comprises:
a buoyant body, which is an U-shaped tube, wherein the said buoyant body is consisted of a first cladding and foam material filled in the first cladding_{;}
a bottom plate, set on the bottom of the buoyant body; and
a tail plate, set at the rear of the buoyant body and the bottom plate;
characterized in that:
the first cladding of the first cladding of the buoyant body is consisted of a first inner layer and two first outer layers, which clad the first inner layer, wherein the first inner layer is a net, while the first outer layers are sheets.

2. The boat with an improved buoyant body as claim 1, characterized in that:
the first inner layer is made of steel wire; while the first outer layers are made of polyvinyl chloride.

3. The boat with an improved buoyant body as claim 1, characterized in that:
the first outer layers are fixed therebetween by melt bonding method.

4. The boat with an improved buoyant body as claim 1, characterized in that:
outside around the buoyant there is a cylindric anti-collision tube.

5. The boat with an improved buoyant body as claim 4, characterized in that:
the anti-collision tube is consisted of a second inner layer and two outer layers, which clad the second inner layer.

6. The boat with an improved buoyant body as claim 5, characterized in that:
the second inner layer is made of steel wire net; the second outer layers are made of polyvinyl chloride sheet.

7. The boat with an improved buoyant body as claim 6, characterized in that:
the both second outer layers are fixed therebetween by melt bonding method.
